(19) United States
(12) Patent Application Publication
(10) Pub. No.: US 2026/0356415 A1
(43) Pub. Date: Nov. 12, 2026

(54) CONNECTING JOINT, SUPPORTING DEVICE FOR CHILD CARRIER AND CHILD CARRIER

(71) Applicant: WONDERLAND SWITZERLAND AG, Steinhausen (CH)

(72) Inventors: Erxue WANG, Dongguan, Guangdong (CN); Mingxing SUN, Dongguan, Guangdong (CN)

(73) Assignee: WONDERLAND SWITZERLAND AG, Steinhausen (CH)

(21) Appl. No.: 19/131,481

(22) PCT Filed: Nov. 20, 2023
(86) PCT No.: PCT/EP2023/082422

§ 371 Date: May 20, 2025

(30) Foreign Application Priority Data
Nov. 21, 2022 (CN) 202211459699.9

(51) Int. Cl. B62B 7/06; B62B 7/08; B62B 7/14; B62B 9/12

(52) U.S. Cl. CPC B62B 7/062; B62B 7/064; B62B 7/083; B62B 7/142; B62B 9/12; B62B 2205/20

(57) ABSTRACT

The present disclosure relates to a connecting joint, a supporting device, and a child carrier. The connecting joint includes: a first rotating base; a first mounting base rotatably connected to the first rotating base and configured to detachably mount a second mounting base of a child carrying device; a first locking member mounted between the first rotating base and the first mounting base, the first locking member having a first locking position at which the first rotating base and the first mounting base are locked and a first unlocking position; a first unlocking member; and a second unlocking member. The first unlocking member or the second unlocking member is configured to drive the first locking member to move from the first locking position to the first unlocking position when being driven by a second driving member of the second mounting base.

### CROSS-REFERENCE TO RELATED APPLICATIONS

This application is the national phase under 35 U.S.C. § 371 of PCT international application No. PCT/EP2023/082422, which has an international filing date of Nov. 20, 2023 and claims priority of Chinese Patent Application No. 202211459699.9, filed on Nov. 21, 2022. The contents of the above identified PCT international application and Chinese patent application are hereby incorporated in their entireties by reference for all purposes.

### TECHNICAL FIELD

The present disclosure relates to the field of children's products, and in particular to a connecting joint, a supporting device for a child carrier, and a child carrier.

### BACKGROUND

For the convenience of storage, a frame and a seat of a stroller are generally designed to be foldable. Currently, there are mainly two ways to fold the stroller. One way is that the seat is non-detachably mounted on the frame, and multiple foldable brackets on the same side of the seat and the frame are non-detachably connected through a connecting joint. The connecting joint has a plurality of locking members arranged axially and an unlocking member for controlling the plurality of locking members. When the plurality of locking members are in a locking position, each of the locked brackets is not rotatable about a rotating shaft. When the opening or closing state of the stroller needs to be changed, the unlocking member is pressed, the plurality of locking members will be pushed to an unlocking position synchronously, and each bracket can rotate around the rotating shaft. The other way is that the seat is detachably mounted on the frame, and a mounting base of the seat and a mounting base of the frame are engaged and then latched by a pin. The folding of the seat and the frame is independent of each other. When the opening or folding state of the stroller needs to be changed, the seat is removed from the frame, and the seat and the frame are respectively opened or folded.

### SUMMARY

An object of the present disclosure is to provide a connecting joint which can be folded without disassembling a child carrying device. The present disclosure further provides a supporting device for a child carrier and a child carrier.

A connecting joint includes a first rotating base, a first mounting base, a first locking member, a first unlocking member, and a first unlocking member. The first mounting base is rotatably connected to the first rotating base and configured to detachably mount a second mounting base of a child carrying device. The first locking member is mounted between the first rotating base and the first mounting base. The first locking member has a first locking position at which the first rotating base and the first mounting base are locked and a first unlocking position at which the first rotating base and the first mounting base are unlocked. The first unlocking member and the second unlocking member are mounted on the first mounting base, the first unlocking member or the second unlocking member is operatively connected to the first locking member; the first unlocking member or the second unlocking member is configured to drive the first locking member to move from the first locking position to the first unlocking position when the first unlocking member or the second unlocking member is driven by a second driving member of the second mounting base, so as to enable the first rotating base to rotate relative to the first mounting base.

In one of the embodiments, the first rotating base is located on a first side of the first mounting base, the first unlocking member is located on a second side of the first mounting base, and the second side of the first mounting base is configured to be connected to the second mounting base.

In one of the embodiments, an end surface of the second side of the first mounting base is provided with a mounting recess, and the first unlocking member is located in the mounting recess.

In one of the embodiments, a chamber is formed between the first rotating base and the first mounting base, and the first locking member is a first locking gear capable of axially moving in the chamber. The connecting joint further includes a first elastic returning member mounted in the chamber, and the first elastic returning member is configured to drive the first locking member to the first locking position.

In one of the embodiments, the first unlocking member is rotatably connected to the first mounting base through a first shaft, the first unlocking member includes a first pushing portion configured to push the first locking member. The first rotating base is rotatably connected to the first mounting base through a first rotating shaft, and the first rotating shaft is substantially perpendicular to the first shaft.

In one of the embodiments, the first unlocking member has a first abutting portion configured to be pushed by the second driving member.

In one of the embodiments, the connecting joint further includes a first driving member sandwiched between the first unlocking member and the first locking member. The first unlocking member drives the first locking member through the first driving member.

In one of the embodiments, the second unlocking member is operatively connected to the first unlocking member, and the second unlocking member is configured to be driven by the second driving member, so as to drive the first unlocking member to unlock the first locking member.

In one of the embodiments, the first unlocking member is rotatably connected to the first mounting base through a first shaft. The second unlocking member is rotatably connected to the first mounting base through a second shaft, the second shaft is substantially parallel to the first shaft, a first end of the second unlocking member is engaged with the first unlocking member, a second end of the second unlocking member includes a second abutting portion configured to be pushed by the second driving member.

In one of the embodiments, when the second unlocking member is not subjected to external driving force, the second abutting portion protrudes outward from the first mounting base.

In one of the embodiments, the second abutting portion has an oblique abutting surface, and the second driving member has an oblique pushing surface configured to abut against the oblique abutting surface.

In one of the embodiments, the first unlocking member includes a first connecting portion sleeved on the first shaft, the second unlocking member a second connecting portion sleeved on the second shaft, and the first connecting portion is engaged with the second connecting portion through a toothed structure.

In one of the embodiments, the connecting joint further includes a fixing bracket. The first shaft and the second shaft are connected to the fixing bracket, the first rotating base is located on a first side of the first mounting base, an end surface of a second side of the first mounting base is provided with a mounting recess, and the fixing bracket is mounted in the mounting recess.

A supporting device for a child carrier includes a first rotating frame, a second rotating frame, and the above-mentioned connecting joint. The first rotating frame is connected to the first rotating base, and the second rotating frame is connected to first mounting base.

A child carrier includes a child carrying device and the above-mentioned supporting device. The child carrying device includes the second mounting base.

In one of the embodiments, the child carrying device includes a folding joint, the folding joint includes the second mounting base, the folding joint includes a second rotating shaft, the second driving member is slidably connected to the second mounting base, a sliding direction of the second driving member is substantially perpendicular to the second rotating shaft, and the second driving member slides relative to the second mounting base when the folding joint is folded.

In one of the embodiments, the folding joint further includes a second rotating base, a third rotating base, a second locking member, and a third unlocking member. The second mounting base, the second rotating base, and the third rotating base are rotatably connected to each other through the second rotating shaft. The second locking member has a second locking position at which the second rotating base and the third rotating base are locked and a second unlocking position at which the second rotating base and the third rotating base are unlocked. The third unlocking member is configured to drive the second locking member to move from the second locking position to the second unlocking position, so as to enable the second rotating base to rotate relative to the third rotating base.

In one of the embodiments, the folding joint further includes a third driving member, the second driving member is connected to the second rotating base through the third driving member. The second mounting base and the second rotating base rotate relative to each other, the third driving member drives the second driving member to slide relative to the second mounting base.

In one of the embodiments, the child carrying device further includes a folding joint, the folding joint includes the second mounting base, the folding joint includes a second rotating shaft, the second driving member is slidably connected to the second mounting base, a sliding direction of the second driving member is substantially parallel to the second rotating shaft, and the second driving member slides relative to the second mounting base when the folding joint is folded.

In one of the embodiments, the folding joint further includes a second rotating base, a third rotating base, a third locking member, and a fourth unlocking member. The second mounting base, the second rotating base, the third rotating base and the fourth unlocking member are rotatably connected to each other through the second rotating shaft. The third locking member is mounted between the second mounting base and the second rotating base, the third locking member has a third locking position at which the second mounting base and the second rotating base are locked and a third unlocking position at which the second mounting base and the second rotating base are unlocked. The fourth unlocking member is configured to drive the third locking member to move from the third locking position to the third unlocking position, so as to enable the second mounting base to move relative to the second rotating base, and the second driving member is integrally formed with or attached to the third locking member.

According to the aforementioned connecting joint, the first unlocking member or the second unlocking member can be driven by the second driving member of the child carrying device to unlock the first locking member, so as to enable the first rotating base to rotate relative to the first mounting base. In other words, the connecting joint can be switched from the unfolding state to the folding state without disassembling the child carrying device, thereby simplifying the folding operation of the connecting joint and the child carrying device. In addition, different types of child carrying devices can be mounted on the connecting joint, and the first unlocking member or the second unlocking member can be driven by the second driving member of the child carrying device to unlock the first locking member, thereby improving the versatility of the connecting joint.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a perspective view of a child carrier in an unfolding state according to an embodiment of the present disclosure.

FIG. 2 is a side view of the child carrier shown in FIG. 1.

FIG. 3 is a partial cross-sectional view taken along the line A-A of FIG. 2, where a first locking member is in a first locking position.

FIG. 4 is a partial cross-sectional view taken along the line A-A of FIG. 2, where the first locking member is in a first unlocking position.

FIG. 5 is a perspective view of the child carrier shown in FIG. 1 in a folding state.

FIG. 6 is a perspective view of the child carrier shown in FIG. 1, where a child carrying device and a supporting device are in a separated state.

FIG. 7 is an exploded view of a connecting joint of the supporting device of the child carrier shown in FIG. 1.

FIG. 8 is similar to FIG. 7, but viewed from another aspect.

FIG. 9 is a side view of the child carrying device of the child carrier shown in FIG. 1 in an unfolding state.

FIG. 10 is a side view of the child carrying device of the child carrier shown in FIG. 1 in a folding state.

FIG. 11 is a partial exploded view of a folding joint of the child carrying device shown in FIG. 9.

FIG. 12 is similar to FIG. 11, but viewed from another aspect.

FIG. 13 is a partial cross-sectional view taken along the line B-B of FIG. 9, where a second locking member is in a second locking position.

FIG. 14 is a partial cross-sectional view taken along the line B-B of FIG. 9, where the second locking member is in a second unlocking position.

FIG. 15 is a cross-sectional view of the folding joint of the child carrying device shown in FIG. 9.

FIG. 16 is a partial exploded view of a second mounting base of the folding joint of the child carrying device shown in FIG. 9.

FIG. 17 is a perspective view of the second mounting base and a third driving member of the folding joint of the child carrying device shown in FIG. 9.

FIG. 18 is a perspective view of a second rotating base and the third driving member of the folding joint of the child carrying device shown in FIG. 9.

FIG. 19 is a front view of the second rotating base of the folding joint of the child carrying device shown in FIG. 9.

FIG. 20 is a partial cross-sectional view taken along A-A of FIG. 2 according to another embodiment of the present disclosure, where the first locking member is in the first locking position.

FIG. 21 is a partial cross-sectional taken along A-A of FIG. 2 according to another embodiment of the present disclosure, where the first locking member is in the first unlocking position.

FIG. 22 is a perspective view of a child carrier according to another embodiment of the present disclosure in an unfolding state.

FIG. 23 is a side view of the child carrier shown in FIG. 22.

FIG. 24 is a partial cross-sectional view taken along C-C of FIG. 23, where the first locking member in the first locking position.

FIG. 25 is a partial cross-sectional view taken along C-C of FIG. 23, where the first locking member is in the first unlocking position.

FIG. 26 is a perspective view of the child carrier shown in FIG. 22 in a folding state.

FIG. 27 is a side view of the child carrying device in the child carrier shown in FIG. 22.

FIG. 28 is a partial cross-sectional view taken along D-D of FIG. 27, where a third locking member is between a third locking position and a third unlocking position.

FIG. 29 is an exploded view of the folding joint of the child carrying device shown in FIG. 27.

FIG. 30 is similar to FIG. 29, but viewed from another aspect.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

It should be noted that, unless otherwise clearly stated and limited, the terms “front”, “rear”, “left” and “right” in the embodiments of the present disclosure are based on the “front”, “rear”, “left” and “right” of a child riding in a child carrier, and arrows F and B are used to schematically show the “front” and “back” directions in the figure, and arrows L and R are used to schematically show the “left” and “right” direction. These directional terms are only used to make the description of the embodiments of the present disclosure clearer and are not used to limit the protection scope of the present disclosure.

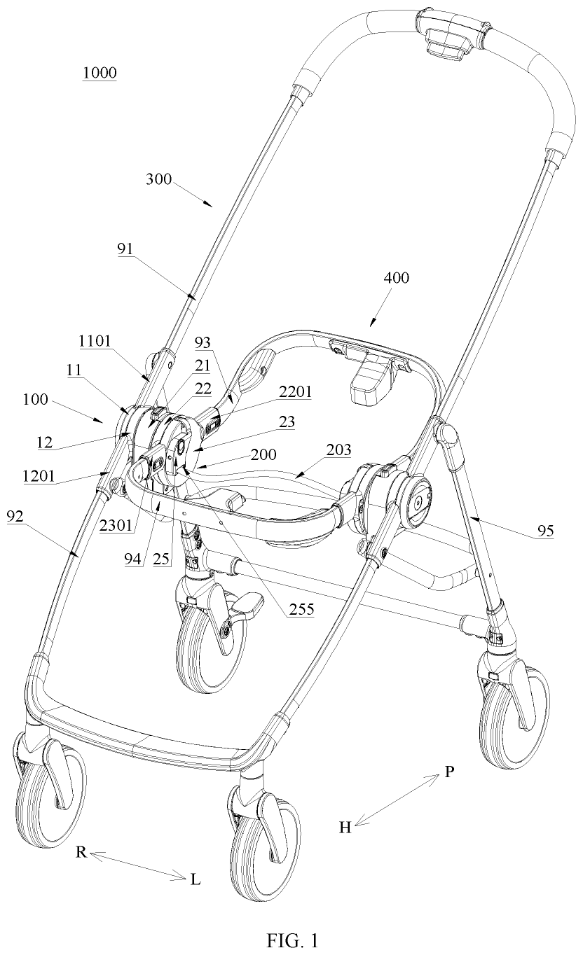

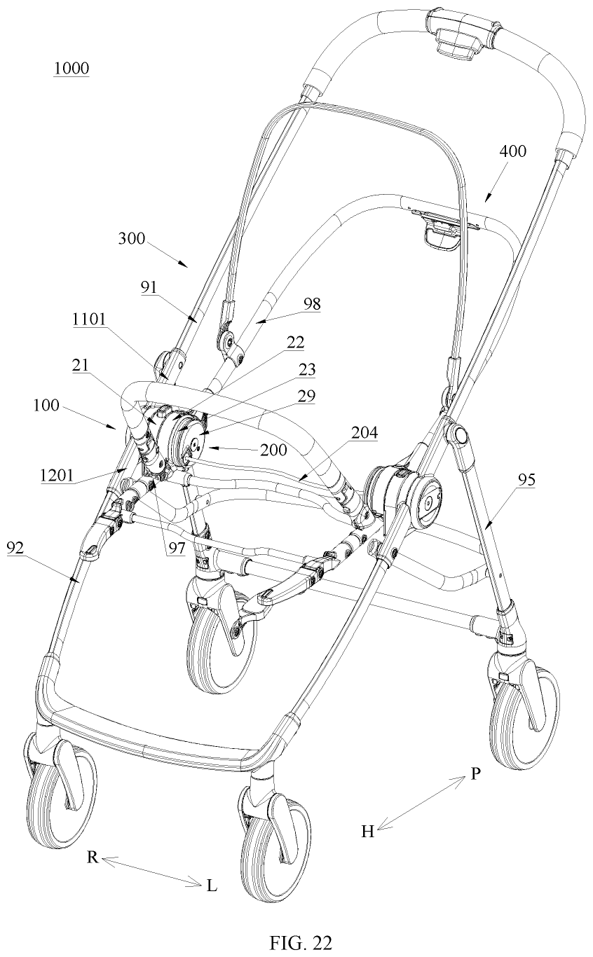

Referring to FIG. 1 and FIG. 22, a child carrier 1000 is provided according to an embodiment of the present disclosure. The child carrier 1000 includes a child carrying device 400 and a supporting device 300. The child carrying device 400 can be detachably mounted on the supporting device 300 as an attachment device. The child carrying device 400 includes a folding joint 200, and the supporting device 300 includes a connecting joint 100. The folding joint 200 is detachably connected to the connecting joint 100, such that the child carrying device 400 is detachably connected to the supporting device 300. In the following embodiments, the child carrier 1000 is described by taking a child stroller as an example. The supporting device 300 is a frame of the child stroller. The child carrying device 400 may be a foldable seat, a foldable frame for use in cooperation with an infant carrier, etc. In alternative embodiments, the child carrier 1000 is not limited to a child stroller, and may be, for example, a child bed frame or other products. Depending on the specific type of the child carrier 1000, the types of the supporting device 300 and the child carrying device 400 may change accordingly. In addition, the application scope of the connecting joint 100 is not limited to the child carrier 1000, and it can be applied to any suitable product.

Referring to FIG. 1, in some embodiments, the child carrier 1000 has a substantially symmetrical structure. The supporting device 300 includes a handlebar 91, a front frame 92, a rear frame 95, a connecting joint 100, etc. The same sides of the handlebar 91 and the front frame 92 are connected by one connecting joint 100, and the handlebar 91 is rotatably connected to the rear frame 95. More specifically, the connecting joint 100 includes a first rotating base 11 and a first mounting base 12. The first rotating base 11 is rotatably connected to the first mounting base 12 through a first rotating shaft 101 (shown in FIG. 3), such that the first rotating base 11 can rotates relative to the first mounting base 12. In some embodiments, the first rotating base 11 includes a connecting barrel 1101, and the handlebar 91 is sleeved in the connecting barrel 1101 as a first rotating frame. The first mounting base 12 includes a connecting barrel 1201, and the front frame 92 is sleeved in the connecting barrel 1201 as a second rotating frame.

Referring to FIG. 1, in some embodiments, the child carrying device 400 includes a front bracket 94, a rear bracket 93, two folding joints 200, etc. The same sides of the front bracket 94 and the rear bracket 93 are connected by one folding joint 200. More specifically, the folding joint 200 includes a second mounting base 21, a second rotating base 22, and a third rotating base 23. The second mounting base 21, the second rotating base 22, and the third rotating base 23 are rotatably connected and can rotate relative to each other. The second mounting base 21 is configured to be detachably mounted to the first mounting base 12 of the connecting joint 100, so that the child carrying device 400 can be detachably mounted to the supporting device 300. In some embodiments, the second rotating base 22 includes a connecting barrel 2201, and the rear bracket 93 is sleeved in the connecting barrel 2201 as a third rotating frame. The third rotating base 23 includes a connecting barrel 2301, and the front bracket 94 is sleeved in the connecting barrel 2301 as a fourth rotating frame.

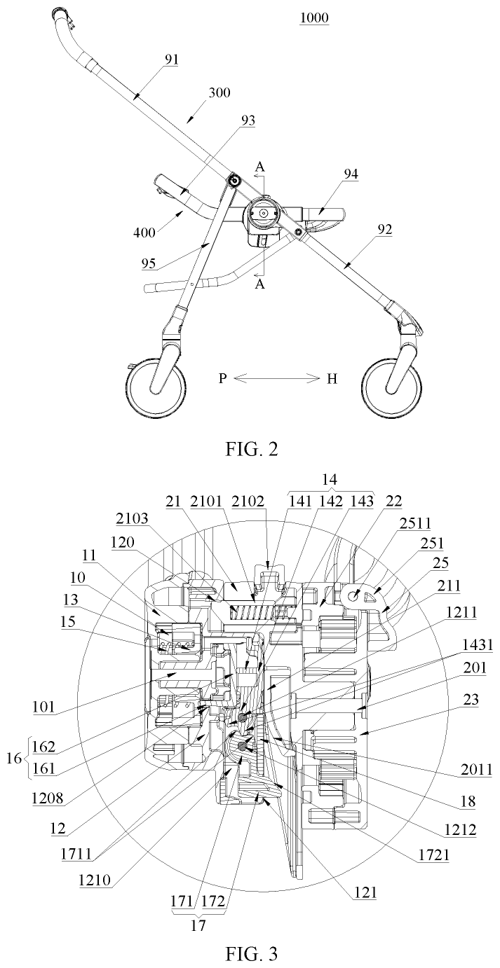

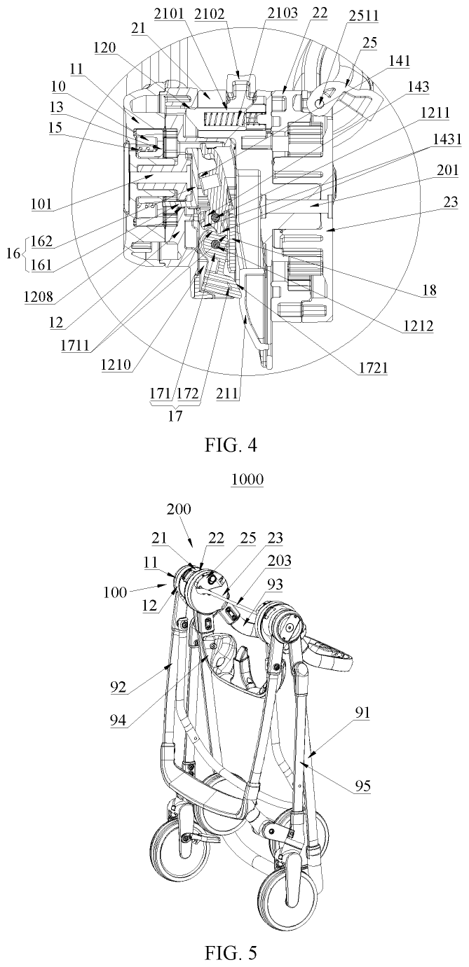

Referring to FIGS. 2 to 4, in some embodiments, the connecting joint 100 further includes a first locking member 13, and the first locking member 13 is mounted between the first rotating base 11 and the first mounting base 12. The first locking member 13 has a first locking position and a first unlocking position. In some embodiments, a chamber 10 is formed between the first rotating base 11 and the first mounting base 12, and the first locking member 13 may be a first locking gear and is axially movably disposed in the chamber 10. More specifically, referring to FIGS. 3, 4, 7 and 8, the first rotating shaft 101 extends through a center hole 1100 of the first rotating base 11, a center hole 1300 of the first locking member 13, and a center hole 1200 of the first mounting base 12. In some embodiments, the first rotating base 11 has an inner ring gear 113, and the first mounting base 12 has an inner ring gear 123. Referring to FIG. 3, when the first locking member 13 is in the first locking position, the first locking member 13 are engaged with the inner ring gear 113 and the inner ring gear 123 at the same time, thereby locking the first rotating base 11 and the first mounting base 12. Referring to FIG. 4, when the first locking member 13 is in the first unlocking position, the first locking member 13 moves along the first rotating shaft 101 into the first rotating base 11 and is disengaged from the inner ring gear 123 of the first mounting seat 12, then the first rotating base 11 can rotate relative to the first mounting base 12. In some alternative embodiments, the first locking member 13 can be implemented by other embodiments, such as a latch-type structure.

Referring to FIGS. 4, 5 and 7, in some embodiments, the connecting joint 100 further includes a first elastic returning member 15 mounted in the chamber 10. The first elastic returning member 15 is configured to exert a force on the first locking member 13 to return the first locking member 13 to the first locking position. In some embodiments, the first elastic returning member 15 is a spring, and the spring is located between the first rotating base 11 and the first locking member 13. In some alternative embodiments, depending on the implementation of the first locking member 13, the implementation of the first elastic returning member 15 also changes accordingly.

Referring to FIGS. 2 to 5, in some embodiments, the connecting joint 100 further includes a first unlocking member 14. The first unlocking member 14 is mounted on the first mounting base 12 and is operatively connected to the first locking member 13. The first unlocking member 14 is configured to drive the first locking member 13 to move from the first locking position to the first unlocking position. In some embodiments, the first unlocking member 14 is rotatably connected to the first mounting base 12 through a first shaft 1211, and the first shaft 1211 is substantially perpendicular to the first rotating shaft 101. The first unlocking member 14 includes a first pushing portion 141. When the first unlocking member 14 is driven by a driving force from, for example, a second driving member 211 (the second driving member 211 will be described below), the first pushing portion 141 will rotate around the first shaft 1211, meanwhile the first unlocking member 14 will directly or indirectly push the first locking member 13, such that the first locking member 13 can move from the first locking position to the first unlocking position.

Referring to FIGS. 3 and 4, in some embodiments, the first unlocking member 14 further includes a first abutting portion 142. The first abutting portion 142 may be plate-shaped, and the first pushing portion 141 may be formed by extending the first abutting portion 142. The function of the first abutting portion 142 will be explained below.

Referring again to FIGS. 2 and 3, when the child carrier 1000 is in an unfolding state, the supporting device 300 and the child carrying device 400 are both in the unfolding state, and the first locking member 13 is in the first locking position. Accordingly, the first locking member 13 in the first locking position locks the first rotating base 11 and the first mounting base 12, such that the first rotating base 11 and the first mounting base 12 cannot rotate relative to each other. Referring to FIGS. 4 and 5, when folding the child carrier 1000, the child carrying device 400 can be firstly folded. During the folding process of the child carrying device 400, the second driving member 211 mounted on the second mounting base 21 of the folding joint 200 will move, such that it indirectly drives the first unlocking member 14 of the connecting joint 100 of the supporting device 300 to move, and the first unlocking member 14 drives the first locking member 13 to move from the first locking position to the first unlocking position. Accordingly, the first locking member 13 in the first unlocking position unlocks the first rotating base 11 and the first mounting base 12, thus enabling the first rotating base 11 to rotate relative to the first mounting base 12. The supporting device 300 can then be switched from the unfolding state shown in FIG. 2 to a folding state shown in FIG. 5.

The connecting joint 100 provided by the embodiment of the present disclosure can switch the child carrier 1000 from the unfolding state to the folding state without disassembling the folding joint 200 of the child carrying device 400, which simplifies the folding operation of the connecting joint 100, the supporting device 300, and the child carrying device 400. After the child carrying device 400 is detached from the supporting device 300, the user may directly operate the first unlocking member 14 to unlock the first locking member 13.

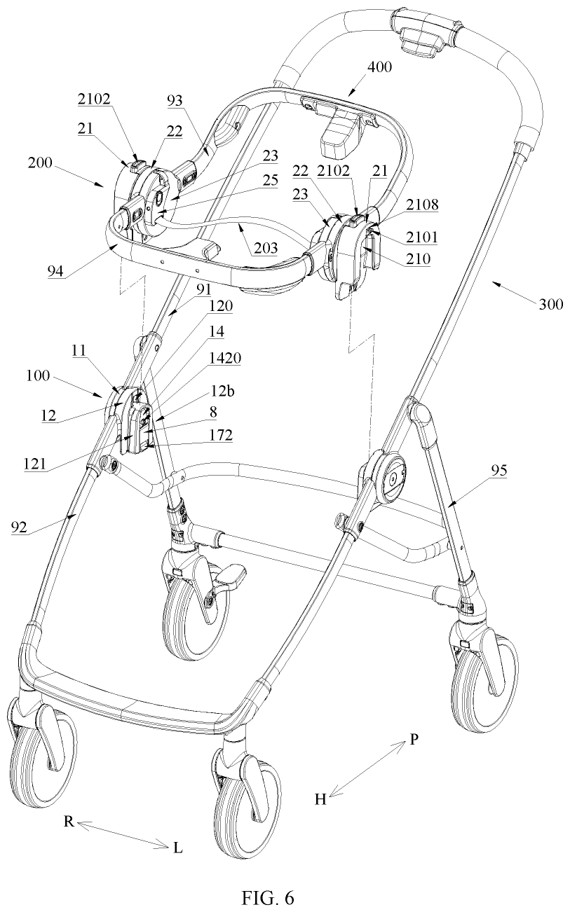

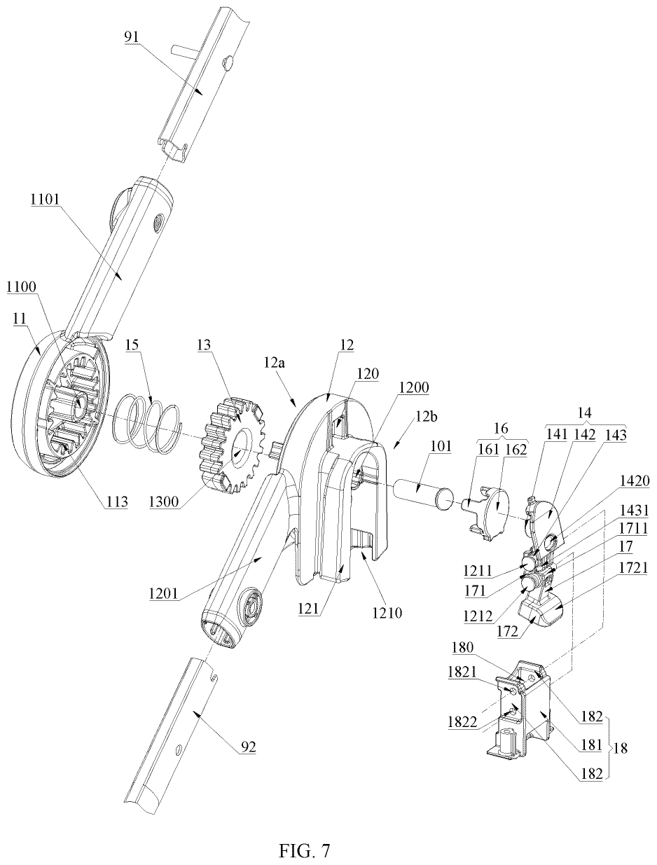

Referring to FIGS. 6 to 7, in some embodiments, the first rotating base 11 is located on a first side 12a (which is also an outer side) of the first mounting base 12, and the first unlocking member 14 is located on a second side 12b (which is also an inner side) of the first mounting base 12. The second side 12b of the first mounting base 12 is configured to be connected to the second mounting base 21. In some embodiments, when the child carrying device 400 is mounted on the supporting device 300, the first locking member 14 is covered by the second mounting base 21, such that the first locking member 14 can be prevented from being accidentally touched. More specifically, when the child carrying device 400 is in an unfolding state and supports a child, the first unlocking member 14 can be prevented from being accidentally touched, which may cause the supporting device 300 to be accidentally folded.

Referring to FIG. 6, exemplary structures of the first mounting base 12 of the connecting joint 100 and the second mounting base 21 of the folding joint 200 are shown. The second side 12b of the first mounting base 12 is provided with a locking hole 120, and the second side 12b of the first mounting base 12 has a U-shaped engaging tab 121 protruding outward. The engaging tab 121 is located below the locking hole 120, and an end surface (i.e., an end surface of the second side 12b) of the tab 120 is provided with a mounting recess 1210 (see FIG. 7). The first unlocking member 14 is located on the mounting recess 1210. A side of the second mounting base 21 facing the first mounting base 12 is provided with a through hole 2108 and a locking slot 210. Referring to FIGS. 3 and 4, a locking member 2101, an unlocking member 2102, and an elastic returning member 2103 are mounted on the second mounting base 21. The locking member 2101 may be a latching pin. The elastic returning member 2103 drives the locking member 2101 to extend out of the through hole 2108. The unlocking member 2102 is operatively connected to the locking member 2101, so as to drive the locking member 2101 to retract into the through hole 2108.

Referring to FIGS. 3, 4 and 6, when the second mounting base 21 is mounted on the first mounting base 12, the locking slot 210 of the second mounting base 21 is engaged with the engaging tab 121 of the first mounting base 12, and the locking member 2101 is inserted into the locking hole 120. When it is required to disassemble the second mounting base 21, the unlocking member 2102 is pressed, the locking member 2101 is driven by the unlocking member 2102 to be out of the locking hole 120, and then the engaging tab 121 of the first mounting base 12 can be disengaged from the locking slot 210 of the second mounting base 21.

Referring to FIGS. 3, 4, 7, and 8, in some embodiments, the connecting joint 100 further includes a first driving member 16. The first driving member 16 is sandwiched between the first unlocking member 14 and the first locking member 13. The first unlocking member 14 indirectly drives the first locking member 13 through the first driving member 16. In some embodiments, the first driving member 16 includes a pushing portion 161 and an abutting portion 162. The abutting portion 162 may be disk-shaped, and the pushing portion 161 includes at least one rod portion extending from the abutting portion 162. The abutting portion 162 is located in the mounting recess 1210 and abuts against the first pushing portion 141 of the first unlocking member 14. A wall of the first mounting base 12 between the mounting recess 1210 and the chamber 10 is provided with at least one through hole 1208. The pushing portion 161 extends through the through hole 1208 and then abuts against the first locking member 13. The pushing portion 161 is slidably engaged with the through hole 1208 to guide the first driving member 16 to move in an axial direction of the first rotating shaft 101. By providing the first driving member 16 that moves in the axial direction of the first rotating shaft 101, the first unlocking member 14 only needs to be able to push the first driving member 16 to move through the first pushing portion 141, thus the design difficulty of the first unlocking member 14 can be reduced.

Referring to FIG. 4, in some embodiments, when a second unlocking member 17 (the second unlocking member 17 will be described below) is driven by the second driving member 211, the first unlocking member 14 will rotate around the first shaft 1211. The rotation of the first unlocking member 14 will drive the first driving member 16 to unlock the first locking member 13, such that the first locking member 13 can move from the first locking position to the first unlocking position. It should be understood that when the driving force exerted by the second driving member 211 on the first unlocking member 14 is removed, the first elastic returning member 15 will drive the first locking member 13 to return to the first unlocking position from the first unlocking position. Correspondingly, the first driving member 16 is driven and reset by the first locking member 13, and the first unlocking member 14 is driven and reset by the first driving member 16. In some alternative embodiments, a torsion spring may be mounted on the first shaft 1211 to reset the first unlocking member 14.

Referring to FIGS. 3 and 4 again, in some embodiments, the connecting joint 100 further includes the second unlocking member 17. The second unlocking member 17 is mounted on the first mounting base 12 and is operably connected to the first unlocking member 14. Accordingly, in some embodiments, when the child carrying device 400 is switched from the unfolding state to the folding state, the second driving member 211 can move in a direction substantially perpendicular to a second rotating shaft 201 (the second rotating shaft 201 will be described below), and the second driving member 211 can drive the first unlocking member 14 through the second releasing member 17 to unlock the first locking member 13.

Referring to FIGS. 3, 4, 7, and 8, in some embodiments, the second unlocking member 17 is located in the mounting recess 1210, and the second unlocking member 17 is rotatably connected to the first mounting base 12 through the second shaft 1212. The second shaft 1212 is substantially parallel to the first shaft 1211. A first end of the second unlocking member 17 is engaged with the first unlocking member 14, and a second end of the second unlocking member 17 includes a second abutting portion 172. In some embodiments, when the child carrying device 400 is switched from the unfolding state to the folding state, the second driving member 211 can move and push the second abutting portion 172 to enable the second locking member 17 to rotate around the second shaft 1212. The rotation of the second unlocking member 17 drives the first unlocking member 14 to rotate around the first shaft 1211, and then the rotation of the first unlocking member 14 drives the first locking member 13 to unlock. On the contrary, when the child carrying device 400 is switched from the folding state to the unfolding state, the second driving member 211 is reset and no longer pushes the second abutting portion 172 of the second unlocking member 17. Accordingly, under the action of the first elastic returning member 15, the first locking member 13, the first driving member 16, and the first unlocking member 14 are reset, and the second unlocking member 17 will be reset along with the first unlocking member 14. In some alternative embodiments, a torsion spring may be mounted on the second shaft 1212 to reset the second unlocking member 17.

Referring to FIGS. 3 and 6, in some embodiments, when the second unlocking member 17 is not subjected to external driving force, the second abutting portion 172 protrudes outward from the first mounting base 12. When the second driving member 211 moves in the direction substantially perpendicular to the second rotating shaft 201, the second driving member 211 can easily push the second abutting portion 172. In some embodiments, the second abutting portion 172 has an oblique abutting surface 1721, and the second driving member 211 has an oblique pushing surface 2011 configured to abut against the oblique abutting surface 1721. The cooperation of the oblique pushing surface 2011 and the oblique abutting surface 1721 helps the second unlocking member 17 to rotate smoothly.

Referring again to FIG. 3 4, 7 and 8, an exemplary locking manner of the first unlocking member 14 and the second unlocking member 17 is shown. The first unlocking member 14 includes a first connecting portion 143 sleeved on the first shaft 1211. The first connecting portion 143 has a first toothed structure 1431. The second unlocking member 17 includes a second connecting portion 171 sleeved on the second shaft 1212. The second connecting portion 171 has a second toothed structure 1711. The first toothed structure 1431 of the first connecting portion 143 is engaged with the second toothed structure 1711 of the second connecting portion 171. This gear engagement between the first unlocking member 14 and the second unlocking member 17 can, on the one hand, increase the pushing stroke of the first unlocking member 14, and on the other hand, reduce the pushing force of the second unlocking member 17 and increases the pushing stability of the second unlocking member 17, thereby increasing the stability and effectiveness of the unlocking process of the connecting joint 100, and achieving a quick closing of the connecting joint 100. In some alternative embodiments, the first unlocking member 14 and the second unlocking member 17 may also be engaged or movably connected through other suitable structures.

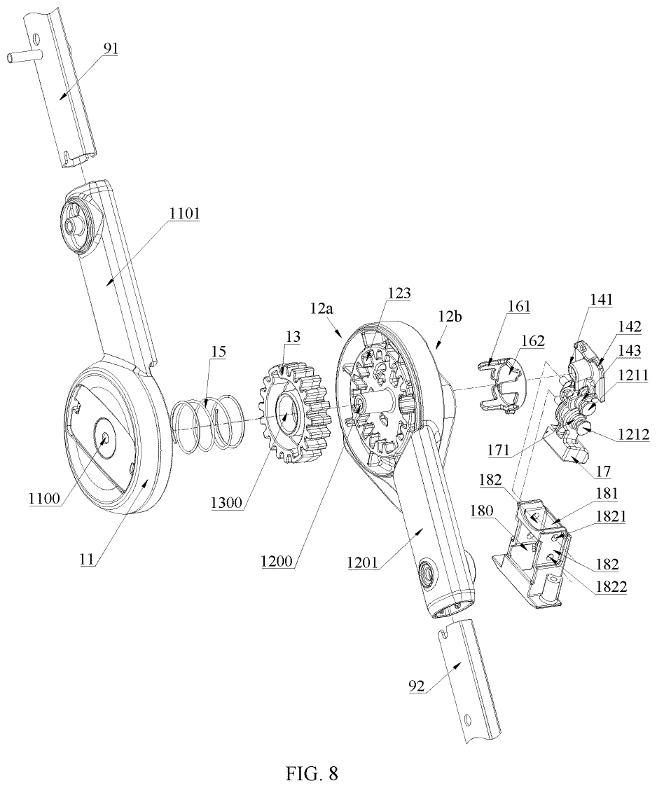

Referring to FIGS. 7 and 8, in some embodiments, the connecting joint 100 may further include a fixing bracket 18. The fixing bracket 18 includes two side walls 182 opposite to each other and a plate 181 connected between the two side walls 182. The plate 181 and the two side walls 182 define a recess 180. The two side walls 182 are provided with two mounting holes 1821 and 1822. The first shaft 1211 is mounted in the mounting hole 1821, and the second shaft 1212 is mounted in the mounting hole 1822. The first connecting portion 143 and the second connecting portion 171 are accommodated in the recess 180. The fixing bracket 18 is mounted in the mounting recess 1210, and the plate 181 partially closes the opening of the mounting recess 1210 to prevent external parts from interfering the engagement of the first connecting portion 143 and the second connecting portion 171.

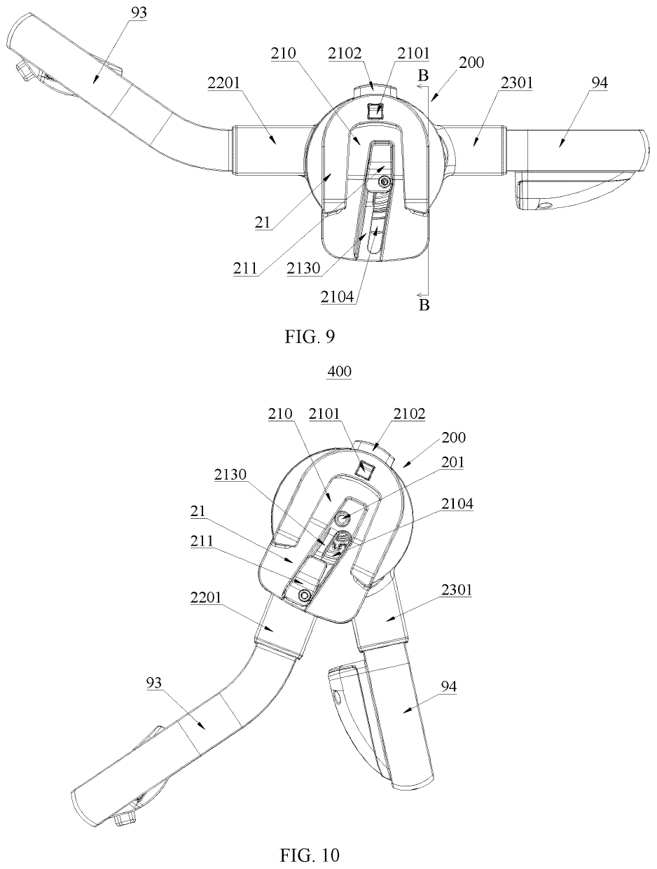

Referring to FIGS. 9 to 12, a schematic structure of the child carrying device 400 and the folding joint 200 in FIG. 1 is shown. The child carrying device 400 may be a folding frame used in combination with an infant carrier. The folding joint 200 includes a second locking member 24, a third unlocking member 25, and the second mounting base 21, the second rotating base 22, and the third rotating base 23. The second rotating shaft 201 (see FIG. 3) extends through a center hole 2100 of the second mounting base 21, a center hole 2200 of the second rotating base 22, and a center hole 2300 of the third rotating base 23, successively. The second mounting base 21, the second rotating base 22, and the third rotating base 23 are rotatably connected to each other through the second rotating shaft 201, so as to rotate relative to each other. The second rotating base 22 is sandwiched between the second mounting base 21 and the third rotating base 23. In some embodiments, a diameter of the center hole 2200 of the second rotating base 22 may be much greater than a diameter of the second rotating shaft 201, and the second rotating base 22 is indirectly rotatably connected to the second rotating shaft 201 through the second mounting base 21 and/or the third rotating base 23.

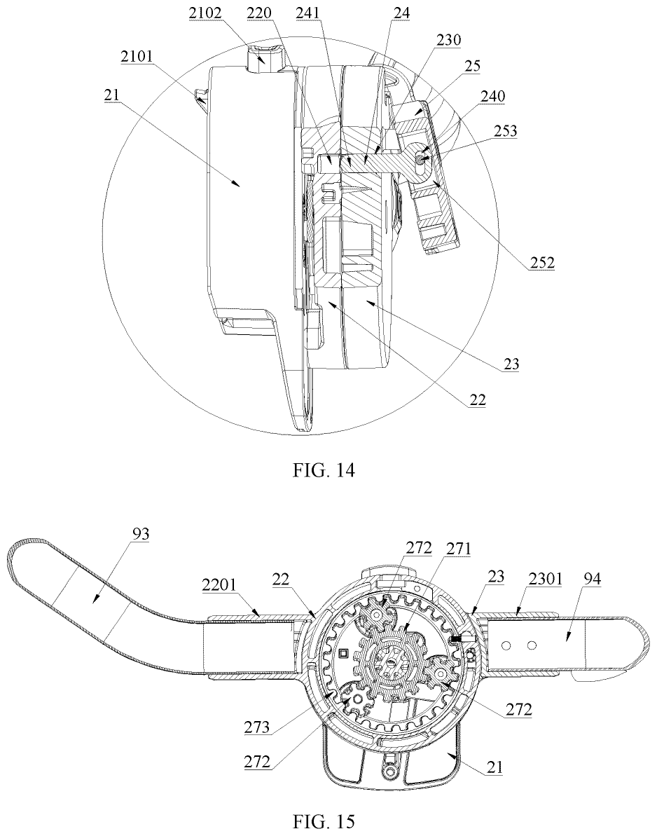

Referring to FIGS. 13 and 14, the second locking member 24 has a second locking position and a second unlocking position. In the second locking position, the second locking member 24 locks the second rotating base 22 and the third rotating base 23, such that the second rotating base 22 and the third rotating base 23 cannot rotate relative to each other, and the child carrying device 400 is maintained in the unfolding state. In the second unlocking position, the second locking member 24 unlocks the second rotating base 22 and the third rotating base 23, such that the second rotating base 22 and the third rotating base 23 can rotate relative to each other, thus allowing the child carrying device 400 to be switched to the folding state. In some embodiments, the second rotating base 22 is provided with a locking hole 220, the third rotating base 23 is provided with a through hole 230, and the second locking member 24 is slidably disposed in the through hole 230. A sliding direction of the second locking member 24 is substantially parallel to the second rotating shaft 201. When the locking hole 220 is aligned with the through hole 230, a first end 241 of the second locking member 24 is inserted into the locking hole 220, such that the second rotating base 22 and the third rotating base 23 are locked. On the contrary, when the first end 241 of the second locking member 24 retracts from the locking hole 220, the second rotating base 22 and the third rotating base 23 are unlocked.

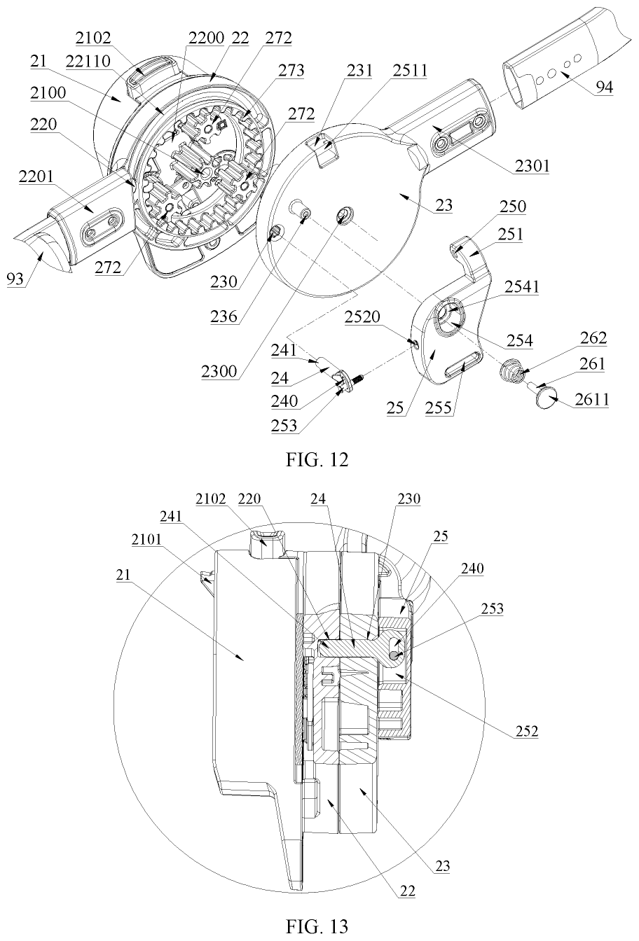

Referring to FIGS. 6 and 12 again, in some embodiments, the third unlocking member 25 is mounted on the third rotating base 23 and is operatively connected to the second locking member 24. The third unlocking member 25 is configured to drive the second locking member 24 to move from the second locking position to the second unlocking position. In some embodiments, the third unlocking member 25 includes a rotating portion 251. The rotating portion 251 has a hole 250, and a rotating shaft 2511 is mounted in the hole 250. In some embodiments, an edge of the third rotating base 23 has a notch 231, and the rotating shaft 2511 is mounted in the notch 231, such that the third unlocking member 25 is rotatably connected to the third rotating base 23 through the rotating shaft 2511. Referring to FIG. 14, a second end of the second locking member 24 is connected to the third unlocking member 25. When the third unlocking member 25 is subjected to external pulling force, the third unlocking member 25 can rotate around the rotating shaft 2511, thus driving the second locking member 24 to move from the second locking position to the second unlocking position. In some embodiments, the third unlocking member 25 is plate-shaped. When the second locking member 24 is in the second locking position, the third unlocking member 25 is configured to attach a side of the third rotating base 23 facing the third rotating base 23 and away from the second rotating base 22.

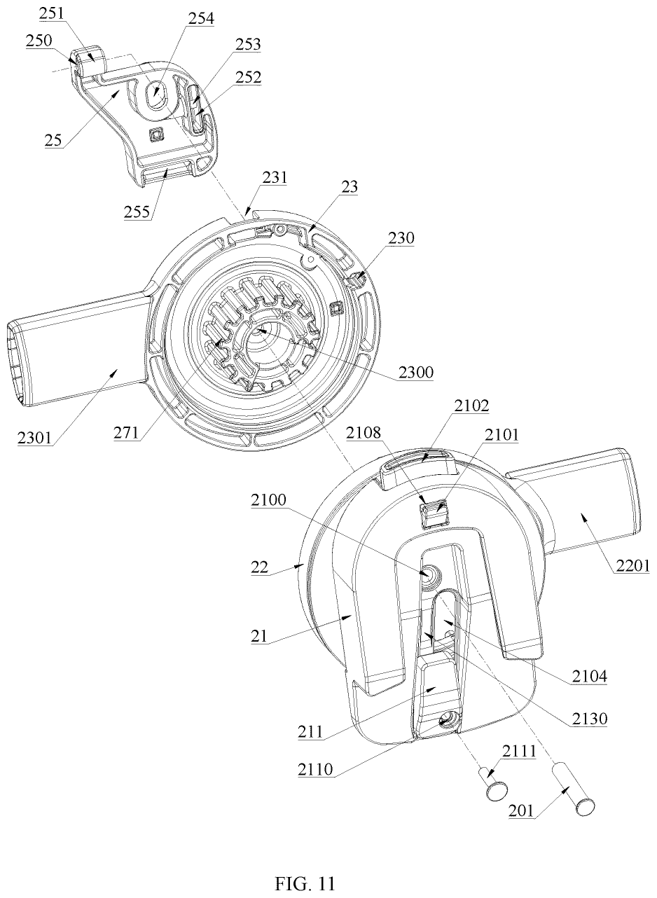

Referring to FIGS. 11 to 14, in some embodiments, the second end of the second locking member 24 is in a sheet shape and is provided with an elongated hole 240. A slot 252 is provided on an inner side of the third unlocking member 25 facing the third rotating base 23, and the second end of the second locking member 24 is inserted into the slot 252. A wall of the slot 252 is provided with a mounting hole 2520. A fastener 253 is mounted in the mounting hole 2520, and a portion of the fastener 253 located in the slot 252 extends through the elongated hole 240. When the third unlocking member 25 is driven by external pulling force to rotate around the rotating shaft 2511, the second locking member 24 moves from the second locking position to the second unlocking position through the cooperation of the fastener 253 and the elongated hole 240.

Referring to FIG. 12, in some embodiments, the third unlocking member 25 is further provided with a hole 255, and a pulling member 203 (see FIG. 1) is connected to the third unlocking member 25 through the hole 255. The left and right ends of the pulling member 203 can be connected to the third unlocking members 25 of the two folding joints 200 on the left and right sides of the child carrying device 400, thereby synchronously driving the second locking members 24 of the two folding joints 200 to be unlocked. In some embodiments, the pulling member 203 may be a webbing, a plastic strip, a rope, etc.

Referring to FIG. 12, in some embodiments, the folding joint 200 may further include an elastic returning member 262. The elastic returning member 262 is configured to drive the third unlocking member 25 to reset, and then drive the second locking member 24 to insert into the locking hole 220. In some embodiments, an elongated counterbore 254 is provided on the third unlocking member 25, and the elongated counterbore 254 has a step portion 2541. A fastener 261 may be mounted on a side of the third rotating base 23 away from the second rotating base 22. The fastener 261 extends through the elongated counterbore 254, and the fastener 261 has a head portion 2611. The fastener 261 is substantially parallel to the second rotating shaft 201. The elastic returning member 262 may be a spring that is sleeved on the fastener 261. Two ends of the spring abut against the head portion 2611 of the fastener 261 and the step portion 2541 of the elongated counterbore 254, respectively. When the third unlocking member 25 is driven by external pulling force to rotate around the rotating shaft 2511, the elastic returning member 262 is compressed. When the external pulling force exerted on the third unlocking member 25 is removed, the elastic return part 262 drives the third unlocking member 25 to reset. In some embodiments, in order to facilitate the mounting of the fastener 261, a protruding post 236 may be provided on the side of the third rotating base 23 away from the second rotating base 22, and the fastener 261 is fixed to a hole (not labeled) of the protruding post 236. In some alternative embodiments, the elastic returning member 262 may be implemented by other means. For example, the elastic returning member 262 may be a torsion spring sleeved on the rotating shaft 2511.

Referring to FIG. 15, in some embodiments, the second mounting base 21, the second rotating base 22, and the third rotating base 23 are linked through a planetary gear train, such that the child carrying device 400 can be unfolded or folded more conveniently and effortlessly. More specifically, referring to FIG. 11, a sun gear 271 is provided on a side of the third rotating base 23 facing the second rotating base 22. Referring to FIG. 17, one or more planet gears 272 are provided on a side of the second mounting base 21 facing the second rotating base 22, and the second mounting base 21 serves as a planet carrier. Referring to FIG. 19, an inner ring gear 273 is provided on a side of the second rotating base 22 facing the third rotating base 23. The sun gear 271, the planet gears 272, and the inner ring gear 273 constitute the planetary gear train. Referring to FIG. 15 again, when one of the second rotating base 22 and the third rotating base 23 is stressed (the stress condition includes a condition that at least one of the second rotating base 22 and the third rotating base 23 is only subjected to gravity under the premise that the folding joint 200 is unlocked), under the action of the planetary gear train, the second mounting base 21, the second rotating base 22, and the third rotating base 23 rotate around the second rotating shaft 201, such that the child carrier 400 can be folded quickly and effortlessly.

It should be understood that when the child carrying device 400 needs to be unfolded, force can be applied to one of the second rotating base 22 and the third rotating base 23. Under the action of the planetary gear train, the folding joint 200 can be switched to the unfolding state easily and quickly.

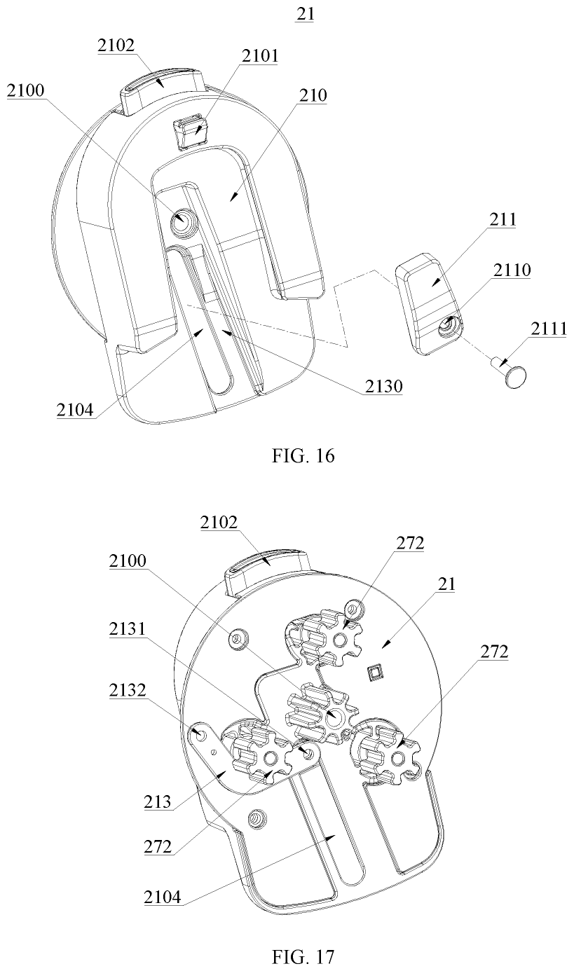

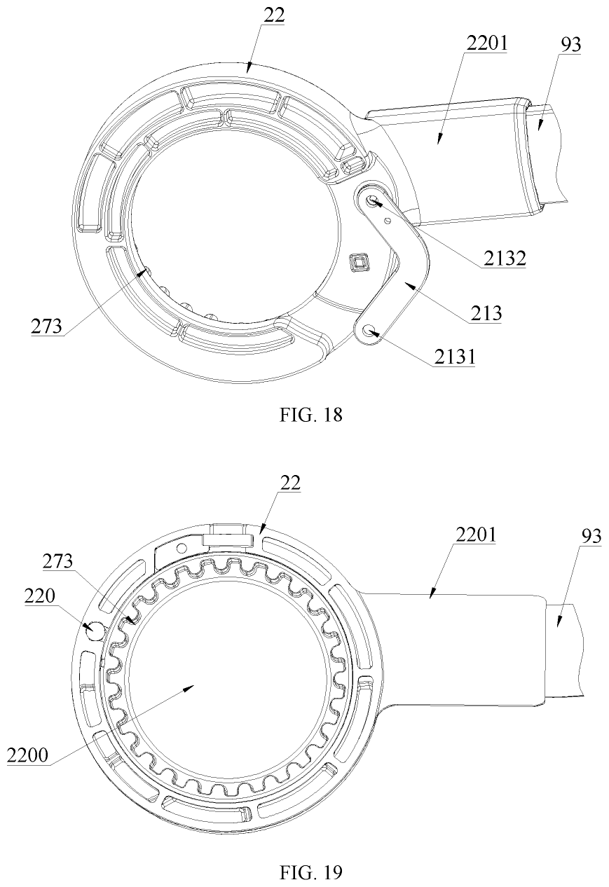

Referring to FIGS. 16 to 18, in some embodiments, the second driving member 211 is slidably connected to the second mounting base 21, and the second driving member 211 is connected to the second rotating base 22 through the third driving member 213. When the folding joint 200 is folded, the second mounting base 21 and the second rotating base 22 rotate relative to each other, and the third driving member 213 drives the second driving member 211 to slide relative to the second mounting base 21 along a direction substantially perpendicular to the second rotating shaft 201. More specifically, a sliding groove 2130 is provided on an outer side of the second mounting base 21, and the second driving member 211 is slidably disposed in the sliding groove 2130. An elongated hole 2104 is provided in the sliding groove 2130. The third driving member 213 is, for example, a bent connecting rod, which is arranged between the second mounting base 21 and the second rotating base 22. A first end of the third driving member 213 is provided with a hole 2131, the second driving member 211 has a hole 2110, and the rotating shaft 2111 extends through the hole 2110, the elongated hole 2104 and the hole 2131. That is, the first end of the third driving member 213 is rotatably connected to the second driving member 211 through the rotating shaft 2111. A second end of the third driving member 213 is provided with a hole 2132, and the third driving member 213 is rotatably connected to an edge of the second rotating base 22 through a rotating shaft (not labeled in the figure) extending through the hole 2132.

Referring again to FIG. 9, when the child carrying device 400 is in the unfolding state, the second driving member 211 is located at a first end of the sliding groove 2130. Referring to FIG. 10, when the child carrying device 400 is in the folding state, the second driving member 211 is located at a second end of the sliding groove 2130. Referring to FIGS. 3 and 4, the change in position of the second driving member 211 can drive the second unlocking member 17 to rotate, thereby indirectly driving the first lock unlocking member 14 to rotate to unlock the first locking member 13.

Referring again to FIG. 12, in some embodiments, the second rotating base 22 may also be provided with a limiting groove 22110 extending in an arc shape, and the limiting groove 22110 is configured to be in slidably fit with the second locking member 24. More specifically, when the third unlocking member 25 is pulled and the second locking member 24 retracts from the locking hole 220, the second rotating base 22 and the third rotating base 23 can first be slightly rotated relative to each other, and then the external pulling force exerted on the third unlocking member 25 can be released, and under the action of the elastic returning member 262, the third unlocking member 25 is reset while driving the second locking member 24 to be inserted into the limiting groove 22110. The limiting groove 22110 can limit the rotation angle range of the second rotating base 22 and the third rotating base 23. In some embodiments, the limiting groove 22110 is in communication with the locking hole 220 through a slit. It should be understood that the second locking member 24 cannot extend through the slit from one of the limiting groove 22110 and the locking hole 220 into the other one thereof.

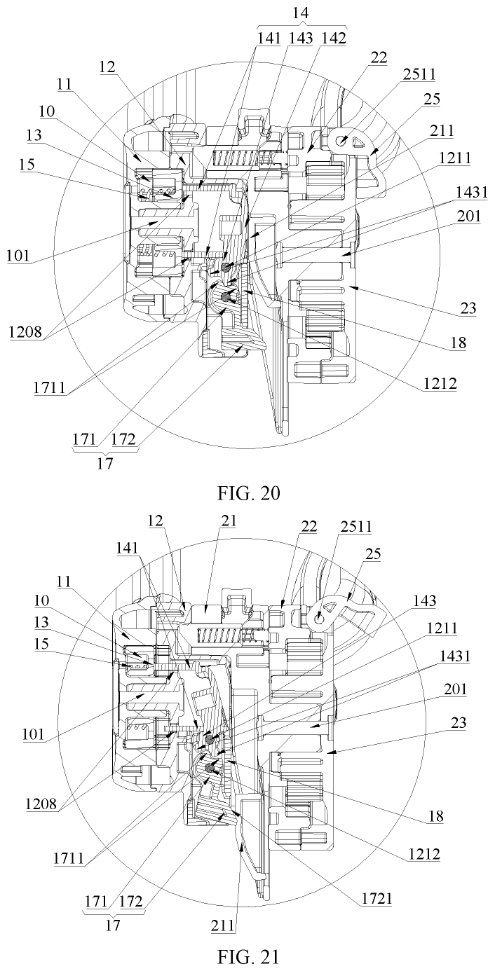

FIGS. 20 and 21 show another embodiment of the connecting joint 100 according to the present disclosure. The difference between the connecting joint 100 in this embodiment and the connecting joint 100 described above lies in that the first driving member 16 is removed, and the first pushing portion 141 of the first unlocking member 14 includes at least one rod portion. The first pushing portion 141 extends through at least one through hole 1208 of the first mounting base 12 and directly abuts against the first locking member 13, which helps reduce the number of parts and facilitates assembly.

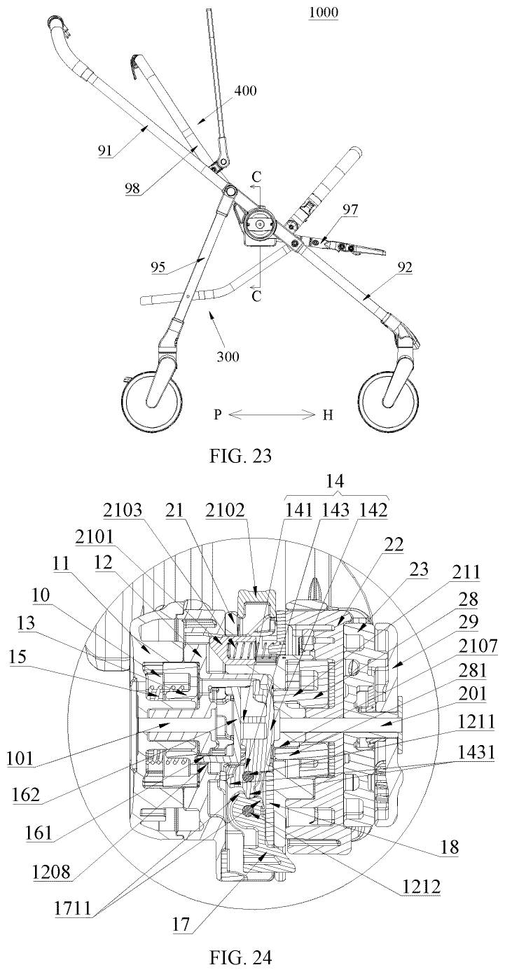

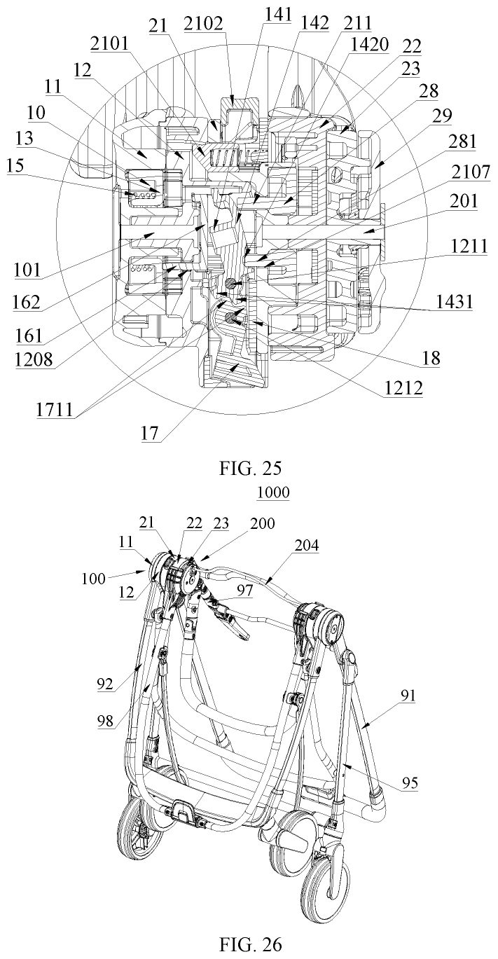

FIGS. 22 and 23 show another embodiment of a child carrier 1000 according to the present disclosure. The child carrier 1000 includes a child carrying device 400 and a supporting device 300. Referring to FIGS. 24 and 25, the supporting device 300 has the same structure as the aforementioned supporting device 300. The structure of the connecting joint 100 of the supporting device 300 can be referred to the above description and will not be repeated here. The difference between this child carrier 1000 shown in FIG. 22 and the child carrier 1000 shown in FIG. 1 lies in that the child carrying device 400 is a foldable seat, and the structure of the child carrying device 400 and the folding joint 200 is different from that in the foregoing embodiments. Similarly, the implementation of the second driving member 211 is also different from the foregoing embodiments.

Referring to FIGS. 24 to 26, the child carrying device 400 includes a seat tube 97, a backrest tube 98, a folding joint 200, etc. The same sides of the seat tube 97 and the backrest tube 98 are connected by the folding joint 200. More specifically, the folding joint 200 includes a second mounting base 21, a second rotating base 22, a third rotating base 23, a third locking member 28, and a fourth unlocking member 29. The second mounting base 21, the second rotating base 22, the third rotating base 23, and the fourth unlocking member 29 are rotatably connected together, so as to rotate relative to each other. The third locking member 28 is configured to lock the second mounting base 21 and the second rotating base 22, and the fourth unlocking member 29 is configured to drive the third locking member 28 to be unlocked.

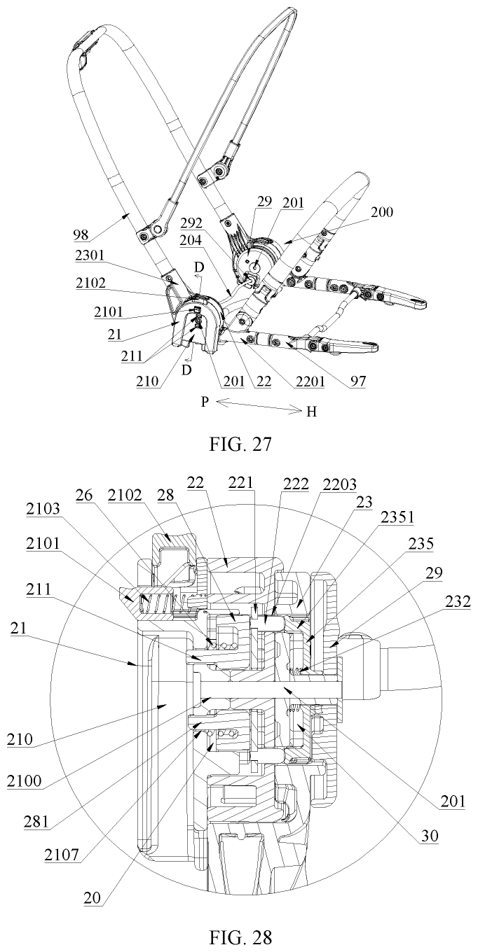

Accordingly, the second mounting seat 21 is configured to be detachably mounted on the first mounting seat 12 of the connecting joint 100, such that the child carrying device 400 can be detachably mounted on the supporting device 300. Referring to FIG. 27, in some embodiments, the second rotating base 22 includes a connecting barrel 2201, and the seat tube 97 is sleeved in the connecting barrel 2201 of the second rotating base 22 as a fifth rotating frame. The third rotating base 23 includes a connecting barrel 2301, and the backrest tube 98 is sleeved in the connecting barrel 2301 of the third rotating base 23 as a sixth rotating frame.

Referring to FIGS. 28 to 30, exemplary structures of the child carrying device 400 and the folding joint 200 in FIG. 22 are shown. A second rotating shaft 201 extends through a center hole 2100 of the second mounting base 21, a center hole 2200 of the second rotating base 22, a center hole 2300 of the third rotating base 23, and a center hole 2900 of the fourth unlocking member 29, successively. The second mounting base 21, the second rotating base 22, the third rotating base 23, and the fourth unlocking member 29 are rotatably connected to each other through the second rotating shaft 201, so as to rotate relative to each other. The second rotating base 22 is sandwiched between the second mounting base 21 and the third rotating base 23, and the third rotating base 23 is sandwiched between the second rotating base 22 and the fourth unlocking member 29.

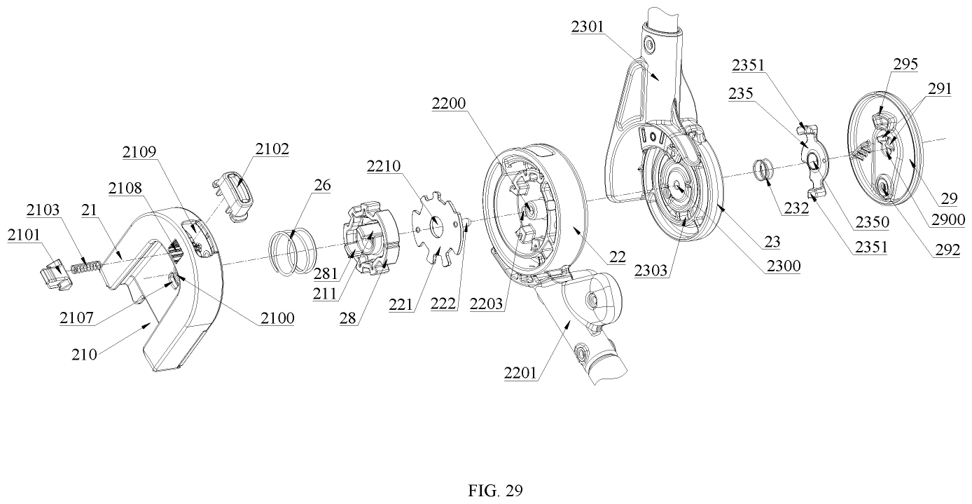

Similar to the forgoing embodiments, a side of the second mounting base 21 facing the first mounting base 12 is provided with a through hole 2108, a through hole 2109, and a locking slot 210. Referring to FIGS. 28 and 29, a locking member 2101, an unlocking member 2102, and an elastic returning member 2103 are mounted on the second mounting base 21. The elastic returning member 2103 drives the locking member 2101 to protrude from the through hole 2108. The unlocking member 2102 extends into the second mounting base 21 through the through hole 2109 and is operably connected to the locking member 2101, so as to drive the locking member 2101 to retract into the through hole 2108. When the second mounting base 21 is mounted on the first mounting base 12, the locking slot 210 of the second mounting base 21 is engaged with the engaging tab 121 of the first mounting base 12, and the locking member 2101 is inserted into the locking hole 120. When it is necessary to disassemble the second mounting base 21, the unlocking member 2102 is pressed, the locking member 2101 is driven by the unlocking member 2102 to retract from the locking hole 120, and then the locking slot 210 of the second mounting base 21 can be disengaged from the engaging tab 121 of the first mounting base 12.

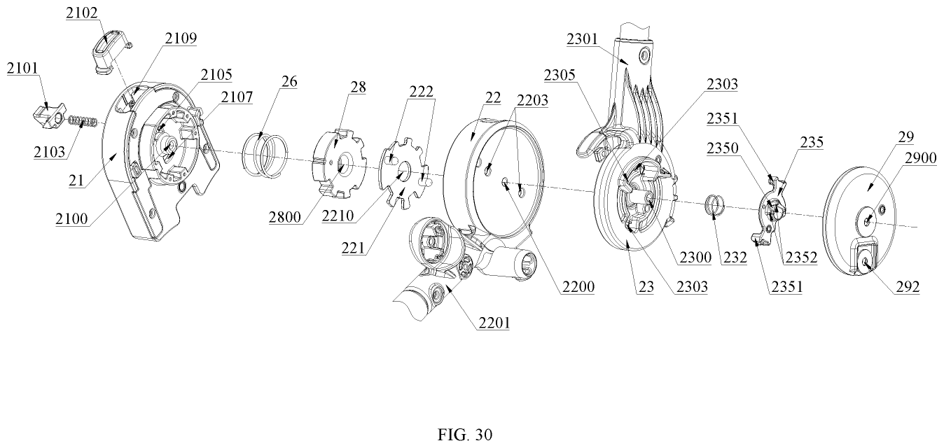

Referring to FIG. 28, in some embodiments, a chamber 20 is formed between the second mounting base 21 and the second rotating base 22, and the third locking member 28 is accommodated in the chamber 20. The third locking member 28 may be a toothed wheel having a center hole 2800 (see FIG. 30) sleeved on the second rotating shaft 201. The third locking member 28 is axially movably disposed in the chamber 20 and has a third locking position and a third unlocking position. When the third locking member 28 is in the third locking position, the third locking member 28 are engaged with the second mounting base 21 and the second rotating base 22 at the same time, such that the relative positions of the second mounting base 21 and the second rotating base 22 can be locked. When the third locking member 28 is in the third unlocking position, the third locking member 28 moves into the second mounting base 21 along the second rotating shaft 201 and is disengaged from the second rotating base 22, and the second mounting base 21 and the second rotating base 22 can rotate relative to each other. In some embodiments, an elastic returning member 26 is mounted in the chamber 20, and the elastic returning member 26 is configured to drive the third locking member 28 to move to the third locking position. The elastic returning member 26 is a spring, which is sandwiched between the second mounting base 21 and the third locking member 28.

Referring to FIGS. 28 and 29, in some embodiments, at least one through hole 2105 is provided on a wall between the locking slot 210 and the chamber 20. The second driving member 211 includes at least one protruding column, which is integrally formed with or attached to the third locking member 28. At least one protruding column of the second driving member 211 is slidably engaged with at least one through hole 2105, such that the second driving member 211 is slidably connected to the second mounting base 21. It should be understood that a sliding direction of the second driving member 211 is substantially parallel to the second rotating shaft 201. As the third locking member 28 is switched between the third locking position and the third unlocking position, the second driving member 211 can extend or retract relative to the through hole 2105.

Referring to FIG. 24, when the third locking member 28 is in the third locking position, the second driving member 211 does not protrude relative to the through hole 2105, and the second driving member 211 does not act on the first unlocking member 14 and the second unlocking member 17 of the connecting joint 100, and the first locking member 13 is in the first locking position. Referring to FIG. 25, when the third locking member 28 is in the third unlocking position, the second driving member 211 protrudes relative to the through hole 2105 and acts as a protruding column of the second driving member 211 to directly push the first abutting portion 142 of the first unlocking member 14, so that the first unlocking member 14 rotates around the first shaft 1211 while directly or indirectly (not through or through the first driving member 16) driving the first locking member 13 to move from the first locking position to the first unlocking position.

Referring to FIGS. 29 and 30, the third locking member 28 further includes at least one protruding column 281. At least one through hole 2107 is provided on the wall between the locking slot 210 and the chamber 20. The protruding column 281 is slidably engaged with the through hole 2107. The protruding column 281 and the protruding column of the second driving member 211 are evenly arranged in the circumferential direction of the third locking member 28, so as to cooperatively guide an axial movement of the second driving member 211. Referring to FIG. 25, the protruding column of the second driving member 211 is located away from the first shaft 1211, and the protruding column 281 is located adjacent to the first shaft 1211. Accordingly, the axial movement of the second driving member 211 pushes the first abutting portion 142 of the first unlocking member 14, drives the first unlocking member 14 to rotate around the first shaft 1211, thereby unlocking the first locking member 13. Referring to FIG. 7 and FIG. 25, in some embodiments, the first abutting portion 142 is plate-shaped and includes an avoiding portion 1420 corresponding to the protruding column 281. The avoiding portion 1420 provides a moving space for the protruding column 281, thereby preventing the protruding column 281 from interfering the rotation of the first unlocking member 14 during normal unlocking.

Referring to FIGS. 28 to 30, in some embodiments, a first movable member 221 is mounted in the chamber 20. The first movable member 221 is sleeved on the second rotating shaft 201 through a center hole 2210 thereof, and the first movable member 221 is located between the third locking member 28 and the second rotating base 22. At least one abutting column 222 is provided on the first movable member 221, and the abutting column 222 extends in a direction away from the third locking member 28. The second rotating base 22 is provided with at least one through hole 2203, and the abutting column 222 is slidably engaged with the through hole 2203.

Referring to FIGS. 28 to 30, in some embodiments, a chamber 30 is formed between the third rotating base 23 and the fourth unlocking member 29. A second movable member 235 is mounted in the chamber 30, and the second movable member 235 is sleeved on the second rotating shaft 201 through a center hole 2350 thereof. The second movable member 235 includes at least one pushing column 2351, the third rotating base 23 is provided with at least one through hole 2303, and the at least one pushing column 2351 is slidably engaged with the at least one through hole 2303. The at least one pushing column 2351 is configured to push the at least one abutting column 222, such that the first movable member 221 pushes the third locking member 28 to move from the third locking position to the third unlocking position. In some embodiments, an elastic returning member 232 may also be provided in the chamber 30, and the elastic returning member 232 is configured to drive the second movable member 235 to move away from the first movable member 221. The elastic returning member 232 is a spring, which is sandwiched between the second movable member 235 and the third rotating base 23.

Referring to FIGS. 29 and 30, in some embodiments, the fourth unlocking member 29 rotates relative to the third rotating base 23 to drive the second movable member 235 to move axially, such that the pushing column 2351 of the second movable member 235 can push the abutting column 222 of the first movable member 221. In some embodiments, at least one first end surface tooth 291 is provided on the fourth unlocking member 29, and at least one second end surface tooth 2352 is provided on the second movable member 235. During the rotation of the fourth unlocking member 29 relative to the third rotating base 23, when protrusions of the first end surface tooth 291 and the second end surface tooth 2352 abut against each other, the second movable member 235 moves axially, and the pushing column 2351 of the second movable member 235 pushes the abutting column 22 of the first movable member 221, causing the first movable member 21 to move, thereby driving the third locking member 28 to move from the third locking position to the third unlocking position. When the protrusions of the first end surface tooth 291 and the second end surface tooth 2352 are staggered, the second movable member 235 will move in a direction away from the first movable piece 231 to reset under the action of the elastic returning member 232. The end surface tooth 2352 and the first end surface tooth 291 have a concave-convex fit.

Referring to FIGS. 29 and 30, in some embodiments, the third rotating member 23 and the fourth unlocking member 29 are provided with rotation limiting mechanisms to limit their relative rotation ranges. For example, an arc-shaped groove 2305 may be provided on the third rotating member 23, and an arc-shaped protrusion 295 may be provided on the fourth unlocking member 29. The arc-shaped protrusion 295 is located in the arc-shaped groove 2305. Two ends of the arc-shaped protrusion 295 are selectively in contact with two ends of the arc-shaped groove 2305, thereby limiting the relative rotation range of the third rotating member 23 and the fourth unlocking member 29. In some embodiments, the positions of the arc-shaped groove 2305 and the arc-shaped protrusion 295 on the third rotating member 23 and the fourth unlocking member 29 may be interchanged.

Referring to FIGS. 29 and 30, in some embodiments, the fourth unlocking member 29 may further be provided with a hole 292, through which the pulling member 204 (see FIG. 22) is connected to the fourth unlocking member 29. When the pulling member 204 is pulled, the fourth unlocking member 29 can rotate relative to the third rotating base 23. The left and right ends of the pulling member 204 can be connected to the fourth unlocking members 29 of the two folding joints 200 on the left and right sides of the child carrying device 400, thereby synchronously driving the third locking members 28 of the two folding joints 200 to be unlocked. In some embodiments, the pulling member 204 may be a webbing, a plastic strip, a rope, etc.

The folding process of the child carrier 1000 will be briefly described below with reference to FIGS. 27 and 28. When it is necessary to fold the child carrier 1000, the backrest tube 98 is firstly pushed forward and downward. At this time, the first end surface tooth 291 and the second end surface tooth 2352 are in concave-convex fit, and the fourth unlocking member 29 rotates along with the third rotating base 23. When the backrest tube 98 is folded in place, the pushing column 2351 of the second movable member 235 is aligned with the abutting column 222 of the first movable member 221. Then a pulling force can be applied to the pulling member 204 to cause the fourth unlocking member 29 to rotate relative to the third rotating base 23. When the protrusion of the first end face tooth 291 and the protrusion of the second end face tooth 2352 abut against each other, the second movable member 235 moves axially, and the pushing column 2351 of the second movable member 235 pushes the abutting column of the first movable member 221 222. The first movable member 221 moves axially. The axial movement of the first movable member 221 drives the third locking member 28 to move to the third unlocking position. The second rotating base 22 and the second mounting base 21 can also rotate relative to each other to further fold the child carrying device 400. In addition, when the third locking member 28 moves to the third unlocking position, the second driving member 211 on the third locking member 28 directly pushes the first unlocking member 14. Referring to FIG. 25, in combination with the above description, it can be seen that the first unlocking member 14 is pushed by the second driving member 211 and then rotates around the first shaft 1211, thereby directly or indirectly driving the first locking member 13 to move to the first unlocking position. At this time, the supporting device 300 can be folded.

When the supporting device 300 is folded in place, the pulling force applied to the pulling member 204 can be remove. Under the action of the elastic returning member 232 and the elastic returning member 26, the second movable member 235 is reset, and the first movable member 221 and the third locking member 28 are reset, such that the first end surface tooth 291 and the second end surface tooth 2352 are in concave-convex fit, and the third locking member 28 moves to the third locking position. The third locking member 28 drives the second driving member 211 to retract into the through hole 2105 and no longer pushes the first unlocking member 14. The first locking member 13 returns to the first locking position under the action of the first elastic returning member 15, and the first locking member 13 drives the first unlocking member 14 to reset.

When the child carrier 1000 is in the folding state, a pulling force is applied to the pulling member 204 to drive the third locking member 28 and the first locking member 13 to move to their respective unlocking positions, so as to conveniently unfold the supporting device 300 and the child carrying device 400 again, thereby unfolding the child carrier 1000.

In summary, according to the supporting device 300 provided by the embodiment of the present disclosure, when the connecting joint 100 is provided with the first unlocking member 14 and the second unlocking member 17, the connecting joint 100 can be detachably connected to the folding joint 200 of different types of child carrying devices 400. When the child carrying device 400 is not detached from the supporting device 300, during the folding process of the child carrying device 400, the first locking member 13 of the connecting joint 100 can be indirectly unlocked through the second driving member 211 of the folding joint 200, such that the supporting device 300 can also be folded.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

1. A connecting joint, comprising:
a first rotating base;
a first mounting base rotatably connected to the first rotating base and configured to detachably mount a mounting base of a child carrying device;
a first locking member mounted between the first rotating base and the first mounting base, wherein the first locking member has a first locking position at which the first rotating base and the first mounting base are locked and a first unlocking position at which the first rotating base and the first mounting base are unlocked; and
a first unlocking member; and
wherein the first unlocking member is rotatably connected to the first mounting base and operatively connected to the first locking member, and the first unlocking member is configured to rotate relative to the first mounting base to drive the first locking member to move from the first locking position to the first unlocking position when the first unlocking member is driven by a driving member of the mounting base of the child carrying device, so as to enable the first rotating base to rotate relative to the first mounting base.

2. The connecting joint according to claim 1, wherein the first rotating base is located on a first side of the first mounting base, the first unlocking member is located on a second side of the first mounting base, and the second side of the first mounting base is configured to be connected to the mounting base of the child carrying device.

3. The connecting joint according to claim 2, wherein an end surface of the second side of the first mounting base is provided with a mounting recess, and the first unlocking member is located in the mounting recess.

4. The connecting joint according to claim 1, wherein a chamber is formed between the first rotating base and the first mounting base, and the first locking member is a first locking gear capable of axially moving in the chamber;
the connecting joint further comprises a first elastic returning member mounted in the chamber, and the first elastic returning member is configured to drive the first locking member to the first locking position.

5. The connecting joint according to claim 1, wherein the first unlocking member is rotatably connected to the first mounting base through a first shaft, the first unlocking member comprises a first pushing portion configured to push the first locking member;
the first rotating base is rotatably connected to the first mounting base through a first rotating shaft, and the first rotating shaft is substantially perpendicular to the first shaft.

6. The connecting joint according to claim 5, wherein the first unlocking member comprises a first abutting portion configured to be pushed by the driving member.

7. The connecting joint according to claim 1, further comprising a first driving member sandwiched between the first unlocking member and the first locking member, wherein the first unlocking member drives the first locking member through the first driving member.

8. The connecting joint according to claim 1, further comprising a second unlocking member rotatably connected to the first mounting base,
wherein the second unlocking member is operatively connected to the first unlocking member, and the second unlocking member is configured to be driven by the driving member, so as to drive the first unlocking member to unlock the first locking member.

9. The connecting joint according to claim 8, wherein the first unlocking member is rotatably connected to the first mounting base through a first shaft;
the second unlocking member is rotatably connected to the first mounting base through a second shaft, the second shaft is substantially parallel to the first shaft, a first end of the second unlocking member is engaged with the first unlocking member, a second end of the second unlocking member comprises a second abutting portion configured to be pushed by the driving member.

10. The connecting joint according to claim 9, wherein when the second unlocking member is not subjected to external driving force, the second abutting portion protrudes outward from the first mounting base.

11. The connecting joint according to claim 9, wherein the second abutting portion has an oblique abutting surface, and the driving member has an oblique pushing surface configured to abut against the oblique abutting surface.

12. The connecting joint according to claim 9, wherein the first unlocking member comprises a first connecting portion sleeved on the first shaft, the second unlocking member comprises a second connecting portion sleeved on the second shaft, and the first connecting portion is engaged with the second connecting portion through a toothed structure.

13. The connecting joint according to claim 9, further comprising a fixing bracket, wherein the first shaft and the second shaft are connected to the fixing bracket, the first rotating base is located on a first side of the first mounting base, an end surface of a second side of the first mounting base is provided with a mounting recess, and the fixing bracket is mounted in the mounting recess.

14. A supporting device for a child carrier, comprising a handlebar, a front frame frame, and the connecting joint according to claim 1, wherein the handlebar is connected to the first rotating base, and the front frame is connected to first mounting base.

15. A child carrier, comprising a child carrying device and the supporting device according to claim 14, wherein the child carrying device comprises the mounting base of the child carrying device.

16. The child carrier according to claim 15, wherein the child carrying device comprises a folding joint, the folding joint comprises the mounting base of the child carrying device, the folding joint comprises a second rotating shaft, the driving member is slidably connected to the mounting base of the child carrying device, a sliding direction of the driving member is substantially perpendicular to the second rotating shaft, and the driving member slides relative to the mounting base of the child carrying device when the folding joint is folded.

17. The child carrier according to claim 16, wherein the folding joint further comprises a second rotating base, a third rotating base, a second locking member, and a third unlocking member, wherein the mounting base of the child carrying device, the second rotating base, and the third rotating base are rotatably connected to each other through the second rotating shaft;
the second locking member has a second locking position at which the second rotating base and the third rotating base are locked and a second unlocking position at which the second rotating base and the third rotating base are unlocked;
the third unlocking member is configured to drive the second locking member to move from the second locking position to the second unlocking position, so as to enable the second rotating base to rotate relative to the third rotating base.

18. The child carrier according to claim 17, wherein the folding joint further comprises a third driving member, the driving member is connected to the second rotating base through the third driving member; when the mounting base of the child carrying device and the second rotating base rotate relative to each other, the third driving member drives the driving member to slide relative to the mounting base of the child carrying device.

19. The child carrier according to claim 15, wherein the child carrying device further comprises a folding joint, the folding joint comprises the mounting base of the child carrying device, the folding joint comprises a second rotating shaft, the driving member is slidably connected to the mounting base of the child carrying device, a sliding direction of the driving member is substantially parallel to the second rotating shaft, and the driving member slides relative to the mounting base of the child carrying device when the folding joint is folded.

20. The child carrier according to claim 19, wherein the folding joint further comprises a second rotating base, a third rotating base, a third locking member, and a fourth unlocking member, wherein the mounting base of the child carrying device, the second rotating base, the third rotating base and the fourth unlocking member are rotatably connected to each other through the second rotating shaft;
the third locking member is mounted between the mounting base of the child carrying device and the second rotating base, the third locking member has a third locking position at which the mounting base of the child carrying device and the second rotating base are locked and a third unlocking position at which the mounting base of the child carrying device and the second rotating base are unlocked;
the fourth unlocking member is configured to drive the third locking member to move from the third locking position to the third unlocking position, so as to enable the mounting base of the child carrying device to move relative to the second rotating base;
the driving member is integrally formed with or attached to the third locking member.
